(19) United States
(12) Patent Application Publication
(10) Pub. No.: US 2018/0230342 A1
(43) Pub. Date: Aug. 16, 2018

(54) PRESSURE-SENSITIVE ADHESIVE ON THE BASIS OF ACRYLONITRILE BUTADIENE RUBBERS

(71) Applicant: TESA SE, Norderstedt (DE)

(72) Inventors: Benjamin PÜTZ, Hamburg (DE); Julia SCHWARZBACH, Hamburg (DE); Maike STREBL, Hamburg (DE); Tobias VON WEDWL-PARLOW, Hamburg (DE); Ralf KRETZMER, Hamburg (DE)

(21) Appl. No.: 15/750,774

(22) PCT Filed: Aug. 8, 2016
(86) PCT No.: PCT/EP2016/068841

§ 371 Date: Feb. 6, 2018

(30) Foreign Application Priority Data
Aug. 11, 2015 (DE) 102015215247.2

(51) Int. Cl. C09J 109/02; C09J 7/25; C09J 7/38; C09J 5/00

(52) U.S. Cl. CPC C09J 109/02; C09J 7/255; C09J 7/383; C09J 5/00; C09J 2467/006; C09J 2205/114; C09J 2203/326; C09J 2203/334; C09J 2409/00

(57) ABSTRACT

The invention relates to pressure-sensitive adhesive material which contains as a base polymer at least one or more solid acrylonitrile butadiene rubbers and adhesive resins, wherein the proportion of adhesive resins is in the range from 30 to 130 phr, characterized in that the acrylonitrile content in the solid acrylonitrile butadiene rubber(s) is between 10 and 30 percent by weight.

The invention relates to the composition of an acrylonitrile-butadiene rubber adhesive and also to the use thereof.

Pressure-sensitive adhesives (PSAs) have been known for some considerable time. PSAs are adhesives which allow durable bonding to the substrate even under relatively weak applied pressure and which after use can be detached again substantially without residue from the substrate. At room temperature, PSAs exhibit a permanently adhesive effect, thus having a sufficiently low viscosity and a high tack, and so wetting the surface of the respective bond substrate even with little applied pressure. The bondability of the adhesives and the redetachability is based on their adhesive properties and on their cohesive properties. A variety of compounds are suitable as a basis for PSAs.

Adhesive tapes equipped with PSAs, referred to as pressure-sensitive adhesive tapes, are nowadays put to diverse uses in the industrial and household spheres. Pressure-sensitive adhesive tapes consist customarily of a carrier film which is furnished on one or both sides with a PSA. There are also pressure-sensitive adhesive tapes which consist exclusively of a layer of PSA and no carrier film, these being referred to as transfer tapes. The composition of the pressure-sensitive adhesive tapes may differ greatly and is guided by the particular requirements of the various applications. The carriers consist customarily of polymeric films such as, for example, polypropylene, polyethylene or polyester, or else of paper, fabric or nonwoven.

The self-adhesive or pressure-sensitive adhesive compositions consist customarily of acrylate copolymers, silicones, natural rubber, synthetic rubber, styrene block copolymers or polyurethanes.

Acrylonitrile-butadiene rubbers, short code NBR, derived from nitrile butadiene rubber, denotes a synthetic rubber which is obtained by copolymerization of a acrylonitrile and buta-1,3-diene in proportions by mass of approximately 52:48 to 10:90. It is produced almost exclusively in aqueous emulsion. The resultant emulsions are used as they are (NBR latex) or processed to be solid rubber. The properties of the nitrile rubber are dependent on the ratio of the initial monomers and on its molar mass. The vulcanizates obtainable from nitrile rubber possess high resistance toward fuels, oils, fats, and hydrocarbons, and are distinguished relative to their natural-rubber counterparts by more favorable aging behavior, lower abrasion and reduced gas permeability. Its weathering resistance, on the other hand, is rather deficient.

Acrylonitrile-butadiene rubbers are available in a wide spectrum. As well as the acrylonitrile content, the various types are distinguished in particular via the viscosity of the rubber. This is usually stated by the Mooney viscosity. This viscosity in turn is determined on the one hand by the number of chain branches in the polymer and on the other hand by the molecular weight. With regard to the polymerization, a distinction is made in principle between what are called cold polymerization and hot polymerization. Cold polymerization takes place customarily at temperatures of 5 to 15° C. and, in contrast to hot polymerization, which is carried out customarily at 30 to 40° C., leads to a lower number of chain branches. NBR rubbers are available from a host of manufacturers such as, for example, Nitriflex, Zeon, LG Chemicals, and Lanxess.

Carboxylated NBR grades come about through terpolymerization of acrylonitrile and butadiene with small fractions of (meth)acrylic acid in emulsion. They are notable for high strength. The selective hydrogenation of the C,C double bond in NBR leads to hydrogenated nitrile rubbers (H-NBR) with improved stability to temperature increase (up to 150° C. in hot air or ozone) or to swelling agents (for example, sulfur-containing crude oils, brake fluids and/or hydraulic fluids). Vulcanization is accomplished with customary sulfur crosslinkers, peroxides, or by means of high-energy radiation.

As well as carboxylated or hydrogenated NBR rubbers there are also liquid NBR rubbers. These rubbers are limited in their molecular weight during the polymerization by the addition of chain transfer agents, and are obtained accordingly as liquid rubbers.

In order to adjust application-relevant properties, PSAs can be modified by the admixing of tackifier resins, plasticizer, crosslinkers or fillers.

Fillers are used, for example, to boost the cohesion of a PSA. In this case a combination of filler/filler interactions and filler/polymer interactions frequently leads to the desired reinforcement of the polymer matrix.

Fillers are also admixed, for the purpose of increasing weight and/or increasing volume in paper, to plastics and also to adhesives and coating materials, and to other products. The addition of filler often improves the technical usability of the products and has an influence on their quality—for example, strength, hardness, etc. The natural, inorganic and organic fillers such as calcium carbonate, kaolin, dolomite and the like are produced mechanically.

In the case of rubber and synthetic elastomers as well, suitable fillers can be used to improve the quality—for example, hardness, strength, elasticity, and elongation. Fillers much in use are carbonates, especially calcium carbonate, or else silicates (talc, clay, mica), siliceous earth, calcium sulfate and barium sulfate, aluminum hydroxide, glass fibers, glass beads, and carbon blacks.

Organic and inorganic fillers can also be distinguished according to their density. Hence the inorganic fillers often used in plastics and also adhesives, such as chalk, titanium dioxide, calcium sulfate and barium sulfate, increase the density of the composite, since they themselves have a density which is higher than that of the polymer. For a given film thickness, the weight per unit area is then higher.

There are also fillers which are able to reduce the overall density of the composite. These include hollow microspheres, very voluminous lightweight fillers. The spheres are filled with air, nitrogen or carbon dioxide; the shells of these spheres consist of glass or else, with certain products, of a thermoplastic.

Besides fillers, the PSAs may also comprise what are called plasticizers. Plasticizers are plasticizing agents such as, for example, low molecular mass polyacrylates, plasticizing resins, phosphates or polyphosphates, paraffinic and naphthenic oils, oligomers such as oligobutadienes and oligoisoprenes, liquid terpene resins, vegetable and animal oils and fats. Plasticizing resins may have the same chemical basis as the tackifier resins listed below, but differ from the latter in their softening point, which is <40° C.

To improve the processing of rubbers, such as the granulating of granules from large rubber bales ahead of further processing in mixers, for example, the rubbers are admixed with inert release assistants such as talc, silicates (talc, clay, mica), zinc stearate, and PVC powders.

The fields of application of electronic devices are increasing in line with their propagation. This is also giving rise to growing requirements of the installed components. For instance, because of the development of body-worn electronic devices (known as wearables) such as smart watches, for instance, it is becoming increasingly important that the adhesive bonds used therein exhibit high resistance toward a variety of chemicals and do not lose peel adhesion even after prolonged storage in a variety of media. Similar requirements are also being imposed increasingly on other electronic devices such as smartphones (cell phones), tablets, notebook computers, cameras, video-cameras, keyboards, touchpads, and the like.

Electronic, optical and precision-mechanical devices for the purposes of this specification are, in particular, devices as classified in Class 9 of the International Classification of Goods and Services for the Registration of Marks (Nice Classification), 10^{th} edition (NCL(10-2013)), to the extent that they are electronic, optical or precision-mechanical devices, and also clocks and chronometers according to Class 14 (NCL(10-2013)), such as, in particular
scientific, marine, measurement, photographic, film, optical, weighing, measuring, signaling, monitoring, rescuing, and instruction apparatus and instruments;
apparatus and instruments for conducting, switching, transforming, storing, regulating, and monitoring electricity;
image recording, processing, transmission, and reproduction devices, such as televisions and the like, for example
acoustic recording, processing, transmission, and reproduction devices, such as broadcasting devices and the like, for example
computers, calculating instruments and data-processing devices, mathematical devices and instruments, computer accessories, office instruments—for example, printers, faxes, copiers, word processors, data storage devices
telecommunications devices and multifunctional devices with a telecommunications function, such as telephones and answering machines, for example
chemical and physical measuring devices, control devices, and instruments, such as battery chargers, multimeters, lamps, and tachometers
nautical devices and instruments
optical devices and instruments
medical devices and instruments and those for sports people
clocks and chronometers
solar cell modules, such as electrochemical dye solar cells, organic
solar cells, thin-film cells,
fire-extinguishing equipment.

Technical development is going increasingly in the direction of devices which are ever smaller and lighter in design, allowing them to be carried at all times by their owner, and usually being generally carried. This is typically accomplished by realization of low weights and/or suitable size of such devices. Such devices are also referred to as mobile devices or portable devices for the purposes of this specification. In this development trend, precision-mechanical and optical devices are increasingly being provided (also) with electronic components, thereby raising the possibilities for minimization. On account of the carrying of the mobile devices, they are subject to increased loads—especially mechanical and chemical loads—for instance by impact on edges, by being dropped, by contact with other hard objects in a bag, or else simply by the permanent motion involved in being carried per se. Mobile devices, however, are also subject to a greater extent to loads due to moisture exposure, temperature effects, and the like, as compared with those “immobile” devices which are usually installed in interiors and which move little or not at all. The adhesive used in accordance with the invention has emerged as being particularly preferred for withstanding such disruptive effects and ideally also mitigating or compensating them.

The invention refers accordingly with particular preference to mobile devices, since the adhesive used in accordance with the invention has a particular benefit here on account of its unexpectedly good properties. Listed below are a number of portable devices, without wishing the representatives specifically identified in this list to impose any unnecessary restriction on the subject matter of the invention.
Cameras, digital cameras, photographic accessories (such as light meters, flashguns, diaphragms, camera casings, lenses, etc.), film cameras, video cameras, small computers (mobile computers, pocket computers, pocket calculators), laptops, notebook computers, netbooks, ultrabooks, tablet computers, handhelds, electronic diaries and organizers (called “Electronic Organizers” or “Personal Digital Assistants”, PDAs, palmtops), modems,
computer accessories and operating units for electronic devices, such as mice,
drawing pads, graphics tablets, microphones, loudspeakers, games consoles, game pads,
remote controls, remote operating devices, touchpads,
monitors, displays, screens, touch-sensitive screens (sensor screens, touchscreen devices), projectors
readers for electronic books (e-books),
mini-TVs, pocket TVs, devices for playing films, video players, radios (including mini and pocket radios), Walkmans, Discmans, music players for e.g. CDs, DVDs, Blu-rays, cassettes, USB, MP3, headphones, cordless telephones, cell phones, smartphones, two-way radios, hands-free devices, devices for summoning people (pagers, beepers)
mobile defibrillators, blood sugar meters, blood pressure monitors, step counters, pulse meters
torches, laser pointers
mobile detectors, optical magnifiers, long-range vision devices, night vision devices, GPS devices, navigation devices, portable interface devices for satellite communications
data storage devices (USB sticks, external hard drives, memory cards)
wristwatches, digital watches, pocket watches, chain watches, stopwatches.

A further area in which chemical-resistant bonding is important is the adhesive bonding of decals or labels for example in environments where there is a possibility of contact with chemicals, such as, for example, the engine compartment, or where it is necessary to ensure security of the label against manipulation, even in cases where different chemicals are used.

It is an object of the invention to portray a possibility by which pressure-sensitive adhesives based on acrylonitrile-butadiene rubbers are available for technical applications, said adhesives exhibiting the profile of properties of customary PSAs, with as far as possible a reduction in costs and with no loss of peel adhesion even after prolonged storage in various media.

This object is achieved by means of a pressure-sensitive as specified in the main claim. The dependent claims relate to advantageous developments of the subject matter of the invention. The invention further encompasses the use of this PSA.

The invention accordingly provides a pressure-sensitive adhesive which comprises as base polymer at least one or a plurality of solid acrylonitrile-butadiene rubber(s) and also tackifier resins, the fraction of the tackifier resins being 30 to 130 phr, and in accordance with the invention the acrylonitrile content in the solid acrylonitrile-butadiene rubber(s) being between 10 and 30 wt %.

The acrylonitrile content in the solid acrylonitrile-butadiene rubber(s) is preferably between 10 and 25 wt %, more preferably between 15 and 20 wt %.

The figures given below in phr denote parts by weight of the relevant component per 100 parts by weight of all solid rubber components of the PSA (solid/solid), in other words, for example, without taking account of the tackifier resins.

The wt% datum is always based on the composition of the overall PSA.

The acrylonitrile-butadiene rubbers may be admixed with inert release assistants such as talc, silicates (talc, clay, mica), zinc stearate, and PVC powders, more particularly in an order of magnitude of 3 phr.

The release assistants are preferably selected from the group consisting of talc, silicates (talc, clay, mica), zinc stearate, and PVC powder.

Furthermore, preferably, the acrylonitrile-butadiene rubber may be admixed with thermoplastic elastomers such as synthetic rubbers, for example, with a fraction of up to 5 wt %, for the purpose of improving the processing qualities.

Particular representatives in this context include the particularly compatible styrene-isoprene-styrene (SIS) and styrene-butadiene-styrene (SBS) grades.

Besides one or more solid acrylonitrile-butadiene rubbers, PSAs of the invention may preferably comprise at least one liquid acrylonitrile-butadiene rubber, in which case the acrylonitrile content in the liquid acrylonitrile-butadiene rubber(s) is likewise between 10 and 30 wt %.

The fraction of the liquid acrylonitrile-butadiene rubbers is preferably up to 20 wt %, more preferably between 1 and 15 wt %, more preferably between 2 and 10 wt %.

Liquid rubbers are distinguished from solid rubbers in that they have a softening point of <40° C.

The figures for the softening point T_{S} of oligomeric and polymeric compounds, such as of the resins, for example, are based on the ring and ball method as per DIN EN 1427:2007, with corresponding application of the provisions (investigation of the oligomer or polymer sample instead of bitumens, with a procedure otherwise retained); the measurements take place in a glycerol bath.

The base polymer preferably consists of solid, or solid and liquid, acrylonitrile-butadiene rubbers, and more preferably there is no other polymer in the PSA apart from the acrylonitrile-butadiene rubbers.

In this case the PSA is a composition of solid and liquid acrylonitrile-butadiene rubbers, one or more tackifiers resins, preferably aging inhibitor(s), and optionally release assistants, which represents one preferred embodiment. Additionally, furthermore, the plasticizers, fillers and/or dyes elucidated later on may optionally be included in small amounts.

Alternatively the base polymer contains more than 90 wt %, preferably more than 95 wt %, of solid and liquid acrylonitrile-butadiene rubber.

The term “tackifier resin” is understood by the skilled person to refer to a resin-based substance which increases the tack.

As tackifier resins it is possible, in the case of the self-adhesive composition, for example, to use hydrogenated and unhydrogenated hydrocarbon resins and polyterpene resins, in particular, as the main component. Suitable with preference, among others, are hydrogenated polymers of dicyclopentadiene (for example, Escorez 5300 series; Exxon Chemicals), hydrogenated polymers of preferably C₈ and C₉ aromatics (for example, Regalite and Regalrez series; Eastman Inc., or Arkon P series; Arakawa). These may originate through hydrogenation of polymers from pure aromatic streams or else may be based through hydrogenation of polymers based on mixtures of different aromatics. Also suitable are partially hydrogenated polymers of C₈ and C₉ aromatics (for example, Regalite and Regalrez series; Eastman Inc., or Arkon M; Arakawa), hydrogenated polyterpene resins (for example, Clearon M; Yasuhara), hydrogenated C₅/C₉ polymers (for example, ECR-373; Exxon Chemicals), aromatic-modified, selectively hydrogenated dicyclopentadiene derivatives (for example Escorez 5600 series, Exxon Chemicals). The aforesaid tackifier resins may be used either alone or in a mixture.

Hydrogenated hydrocarbon resins are particularly suitable as a blend component, as described for example in EP 0 447 855 A1, U.S. Pat. No. 4,133,731 A, and U.S. Pat. No. 4,820,746 A, since there can be no disruption to crosslinking in view of the absence of double bonds.

Furthermore, however, unhydrogenated resins can also be employed, if crosslinking promoters such as polyfunctional acrylates, for example, are used.

Other unhydrogenated hydrocarbon resins, unhydrogenated analogs of the hydrogenated resins described above, can also be used.

Moreover, rosin-based resins (for example, foral, foralyn) can be used.

The aforementioned rosins include, for example, natural rosin, polymerized rosin, partially hydrogenated rosin, fully hydrogenated rosin, esterified products of these kinds of rosin (such as glycerol esters, pentaerythritol esters, ethylene glycol esters, and methyl esters), and rosin derivatives (such as disproportionation rosin, fumaric acid-modified rosin, and lime-modified rosin).

To stabilize the PSA it is common to add primary antioxidants such as, for example, sterically hindered phenols, secondary antioxidants such as, for example, phosphites or thioethers and/or C-radical scavengers.

The tackifier resins may comprise polyterpene resins based on a-pinene and/or 8-pinene and/or δ-limone or terpene-phenolic resins.

Any desired combinations of these may be used in order to adjust the properties of the resulting PSA in line with requirements. Reference may be made expressly to the representation of the state of knowledge in the “Handbook of Pressure Sensitive Adhesive Technology” by Donatas Satas (van Nostrand, 1989).

Resins used with particular preference are terpene-phenolic resins, of the kind sold, for example, by DRT under the trade name Dertophene or by Arizona under the trade name Sylvares.

The amount by weight of the resins is 30 to 130 phr, preferably 50 to 120 phr, more preferably 60 to 110 phr.

To the acrylonitrile-butadiene rubber-based PSA it is possible, for the purpose of adjusting optical and technical adhesive properties, for additives to be included such as fillers, dyes or aging inhibitors (antiozonants, antioxidants (primary and secondary), light stabilizers, etc.)

Additives to the adhesive that are typically utilized are as follows:
primary antioxidants such as, for example, sterically hindered phenols
secondary antioxidants such as, for example, phosphites or thioethers
light stabilizers such as, for example, UV absorbers or sterically hindered amines

The fillers may be reinforcing or nonreinforcing. Particularly noteworthy here are silicon dioxides (spherical, acicular or irregular such as pyrogenic silicas), phyllosilicates, calcium carbonates, zinc oxides, titanium dioxides, aluminum oxides or aluminum oxide hydroxides.

The concentration of the additives influencing the optical and technical adhesive properties is preferably up to 20 wt %, more preferably up to 15 wt %, more preferably up to 5 wt %.

In accordance with the invention the fractions of all substances added (apart from acrylonitrile-butadiene rubber and tackifier resin), such as synthetic rubbers and/or thermoplastic elastomers and/or fillers and/or dyes and/or aging inhibitors, ought not to exceed a total of 5 wt %, preferably 2 wt %.

The substance recited are not mandatory; the adhesive also functions without the addition thereof individually or in any desired combination, in other words without synthetic rubbers and/or elastomers and/or fillers and/or dyes and/or aging inhibitors.

According to one preferred embodiment, the PSA of the invention is foamed. Foaming is accomplished by the introduction and subsequent expansion of microballoons.

“Microballoons” are elastic hollow microspheres, which accordingly can be expanded in their basic state, and which have a thermoplastic polymer shell. These spheres are filled with low-boiling liquids or with liquefied gas. Shell material used includes, in particular, polyacrylonitrile, PVDC, PVC or polyacrylates. Suitable low-boiling liquids are, in particular, hydrocarbons of the lower alkanes, such as isobutane or isopentane, for example, which are included in the form of liquefied gas under pressure in the polymer shell.

Action on the microballoons, and more particularly the action of heat, causes the outer polymer shell to soften. At the same time, the liquid repelling gas present within the shell undergoes transition into its gaseous state. This is accompanied by irreversible stretching of the microballoons, which expand three-dimensionally. Expansion is over when the internal pressure matches the external pressure. Since the polymeric shell is retained, a closed-cell foam is obtained accordingly.

There are a large number of types of microballoon available commercially, which differ essentially in their size (6 to 45 pm in diameter in the unexpanded state) and the onset temperatures they require for expansion (75 to 220° C.). One example of commercially available microballoons are the Expancel® DU products (DU=dry unexpanded) from Akzo Nobel.

Unexpanded types of microballoon are also available as an aqueous dispersion having a solids or microballoon fraction of around 40 to 45 wt %, and additionally in the form of polymer-bound microballoons (masterbatches), as for example in ethyl vinyl acetate with a microballoon concentration of around 65 wt %. The microballoon dispersions and the masterbatches as well, like the DU products, are suitable for producing a foamed PSA of the invention.

A foamed PSA of the invention may also be produced with what are called preexpanded microballoons. In the case of this group, the expansion takes place prior to incorporation into the polymer matrix. Preexpanded microballoons are available commercially, for example, under the designation Dualite® or with the product name Expancel xxx DE (Dry Expanded) from Akzo Nobel.

With preference in accordance with the invention, at least 90% of all the cavities formed by microballoons have a maximum diameter of 10 to 200 μm, more preferably of 15 to 200 μm. The “maximum diameter” means the maximum extent of a microballoon in any three-dimensional direction.

The diameter is determined using a cryofracture edge under a scanning electron microscope (SEM) at 500 times magnification. The diameter of each individual microballoon is determined graphically.

Where foaming takes place using microballoons, the microballoons may be supplied in the form of a batch, paste or an unextended or extended powder to the formulation. They may additionally be present in suspension in solvent.

According to one preferred embodiment of the invention, the fraction of the microballoons in the adhesive is between greater than 0 wt % and 10 wt %, more particularly between 0.25 wt % and 5 wt %, very especially between 0.5 and 1.5 wt %, based in each case on the overall composition of the adhesive.

The figure is based on unexpanded microballoons.

A polymer composition of the invention that comprises expandable hollow microspheres may additionally also include unexpandable hollow microspheres. The only critical issue is that almost all of the gas-containing enclosures are enclosed by a permanently dense membrane, regardless of whether this membrane consists of an elastic and thermoplastically stretchable polymer mixture or, for instance, of elastic glass which is nonthermoplastic in the spectrum of temperatures possible in plastics processing.

Additionally suitable for the PSA of the invention—selected independently of other additives—are solid polymer beads, hollow glass beads, solid glass beads, hollow ceramic beads, solid ceramic beads and/or solid carbon beads (“carbon microballoons”).

The absolute density of a foamed PSA of the invention is preferably 350 to 990 kg/m³, more preferably 450 to 970 kg/m³, more particularly 500 to 900 kg/m³. The relative density describes the ratio of the density of the foamed PSA of the invention to the density of the unfoamed PSA of the invention of identical formula. The relative density of a PSA of the invention is preferably 0.35 to 0.99, more preferably 0.45 to 0.97, more particularly 0.50 to 0.90.

The PSA is utilized preferably for the furnishing of carriers, to give adhesive tapes.

Adhesive tapes in the sense of the invention are to comprehend all sheetlike or tapelike carrier formations coated on one or both sides with adhesive, hence including, in addition to conventional tapes, also decals, sections, diecuts (punched sheetlike carrier formations coated with adhesive), two-dimensionally extended structures (for example, sheets) and the like, and multilayer arrangements.

The expression “adhesive tape” also encompasses, furthermore, what are called “adhesive transfer tapes”, in other words an adhesive tape without carrier. In the case of an adhesive transfer tape, instead, the adhesive is applied between flexible liners prior to application, these liners being provided with a release layer and/or having antiadhesive properties. For application, generally speaking, first one liner is removed, the adhesive is applied, and then the second liner is removed.

The adhesive tape may be provided in fixed lengths, such as in the form of meter-length product, for example, or else as continuous product on rolls (Archimedean spiral).

The coat weight (coating thickness) of the adhesive is preferably between 10 and 150 g/m², more preferably between 15 and 100 g/m², very preferably between 20 and 35 g/m².

Carrier materials used for the pressure-sensitive adhesive tape are the carrier materials customary and familiar to the skilled person, such as paper, woven fabric, nonwoven, or films made, for example, of polyester such as polyethylene terephthalate (PET), polyethylene, polypropylene, oriented polypropylene, polyvinyl chloride. It is likewise possible to use carrier materials made from renewable raw materials such as paper, woven fabric made, for example, of cotton, hemp, jute, stinging-nettle fibers, or films composed, for example, of polylactic acid, cellulose, modified starch, polyhydroxyalkanoate. This recitation should not be understood as being conclusive; instead, within the bounds of the invention, the use of other films is also possible.

Particular preference is given to films made from PET.

The carrier material may be furnished preferably on one or both sides with the PSA.

The pressure-sensitive adhesive tape is formed by application of the adhesive, partially or over the whole area, to the carrier. Coating may also take place in the form of one or more strips in lengthwise direction (machine direction), optionally in transverse direction (cross direction), but coating more particularly is over the full area. Furthermore, the adhesives may be applied in patterned dot format by means of screen printing, in which case the dots of adhesive may also differ in size and/or distribution, or by gravure printing of lines which join up in the lengthwise and transverse directions, by engraved-roller printing, or by flexographic printing. The adhesive may be in the form of domes (produced by screen printing) or else in another pattern such as lattices, stripes, zig-zag lines. Furthermore, for example, it may also have been applied by spraying, producing a more or less irregular pattern of application.

It is advantageous to use an adhesion promoter, referred to as a primer layer, between carrier and adhesive, or to use a physical pretreatment of the carrier surface for the purpose of improving the adhesion of the adhesive to the carrier.

Primers which can be used are the known dispersion systems and solvent systems, based for example on isoprene- or butadiene-containing rubber, acrylate rubber, polyvinyl, polyvinylidene and/or cyclo rubber. Isocyanates or epoxy resins as additives improve the adhesion and in some cases also increase the shear strength of the PSA. The adhesion promoter may likewise be applied by means of a coextrusion layer on one side of the carrier film. Examples of suitable physical surface treatments are flame treatment, corona or plasma, or coextrusion layers.

Furthermore, the carrier material, on the reverse face or upper face, in other words opposite the adhesive side, may have been subjected to an antiadhesive physical treatment or coating, and more particularly may have been furnished with a parting agent or release (optionally blended with other polymers).

Examples are stearyl compounds (for example, polyvinylstearylcarbamate, stearyl compounds of transition metals such as Cr or Zr, ureas formed from polyethylenimine and stearyl isocyanate, or polysiloxanes. The term, stearyl, stands as a synonym for all linear or branched alkyls or alkenyls having a C number of at least 10 such as octadecyl, for example.

Suitable release agents further include surfactant-type release systems based on long-chain alkyl groups such as stearylsulfosuccinates or stearylsulfosuccinamates, but also polymers which may be selected from the group consisting of polyvinylstearylcarbamates such as, for example, Escoat 20 from Mayzo, polyethyleniminestearylcarbamides, chromium complexes of C₁₄ to C₂₈ fatty acids, and stearyl copolymers, as described in DE 28 45 541 A, for example. Likewise suitable are release agents based on acrylic polymers with perfluorinated alkyl groups, silicones based, for example, on poly(dimethylsiloxanes), or fluorosilicone compounds.

The carrier material may further be pretreated and/or after treated. Common pretreatments are hydrophobizing, corona pretreatments such as N₂ corona or plasma pretreatments; familiar after treatments are calendering, heating, laminating, punching, and enveloping.

The pressure-sensitive adhesive tape may likewise have been laminated with a commercial release film or release paper, which customarily comprises a base material of polyethylene, polypropylene, polyester or paper which has been coated with polysiloxane on one or both sides.

The pressure-sensitive adhesive film of the invention may be produced by customary coating methods known to the skilled person. In this context, the PSA, including the additives, in solution in a suitable solvent, may be coated onto a carrier film or release film by means, for example, of engraved-roller application, comma bar coating, multiroll coating, or in a printing process, after which the solvent can be removed in a drying tunnel or drying oven. Alternatively, the carrier film or release film may also be coated in a solvent-free process. For this purpose, the acrylonitrile-butadiene rubber is heated in an extruder and melted. Further operating steps may take place in the extruder, such as mixing with the above-described additives, filtration or degassing. The melt is then coated by means of a calender onto the carrier film or release film.

Possible methods by which acrylonitrile-butadiene rubber-based adhesives like that produced according to the invention are produced are found in DE 198 06 609 A1 and also in patents WO 94/11175 A1, WO 95/25774 A1, WO 97/07963 A1.

The pressure-sensitive adhesive tape of the invention preferably has a peel adhesion on a steel substrate of at least 6.0 N/cm for a coat weight of 50 g/m².

Further details, objectives, features, and advantages of the present invention will be elucidated in more detail below by reference to a number of figures which represent preferred working examples. In these figures

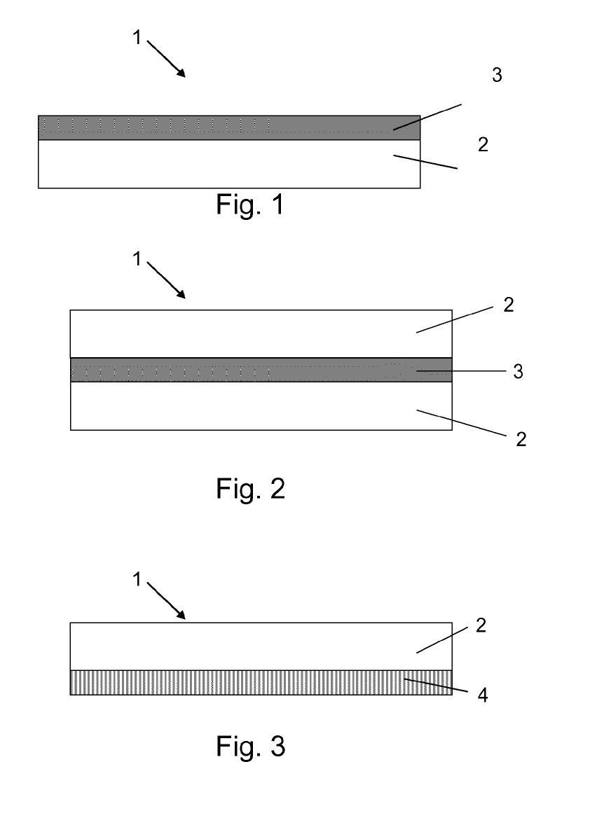

FIG. 1 shows a single-sided pressure-sensitive adhesive tape,

FIG. 2 shows a double-sided pressure-sensitive adhesive tape,

FIG. 3 shows a carrier-free pressure-sensitive adhesive tape (adhesive transfer tape).

FIG. 1 shows a single-sidedly adhering pressure-sensitive adhesive tape 1. The pressure-sensitive adhesive tape 1 has an adhesive layer 2 produced by coating one of the above-described PSAs onto a carrier 3. The PSA coat weight is preferably between 10 and 50 g/m².

Provided additionally (not shown) may be a release film, which covers and protects the adhesive layer 2 before the pressure-sensitive adhesive tape 1 is used. The release film is then removed before use from the adhesive layer 2.

The product construction shown in FIG. 2 shows a pressure-sensitive adhesive tape 1 with a carrier 3, coated on both sides with a PSA and therefore having two adhesive layers 2. The PSA coat weight per side is in turn preferably between 10 and 200 g/m².

With this embodiment as well, at least one adhesive layer 2 is preferably lined with a release film. In the case of a rolled-up adhesive tape, this one release film may optionally also line the second adhesive layer 2. However, it is also possible for a plurality of release films to be provided.

It is possible, furthermore, for the carrier film to be provided with one or more coatings. Moreover, only one side of the pressure-sensitive adhesive tape may be furnished with the inventive PSA, and a different PSA may be used on the other side.

The product construction shown in FIG. 3 shows a pressure-sensitive adhesive tape 1 in the form of an adhesive transfer tape, in other words a carrier-free pressure-sensitive adhesive tape 1. For this construction, the PSA is coated single-sidedly onto a release film 4, to form a pressure-sensitive adhesive layer 2. The PSA coat weight here is customarily between 10 and 100 g/m². This pressure-sensitive adhesive layer 2 is optionally also lined on its second side with a further release film. For the use of the pressure-sensitive tape, then, the release films are removed.

As an alternative to release films it is also possible for example to use release papers or the like. In that case, however, the surface roughness of the release paper ought to be reduced, in order to realize a PSA side that is as smooth as possible.

In order to enhance the cohesive properties of the PSA, it may also be crosslinked with the methods described above and, in particular, through the addition of peroxides, or with irradiation with high-energy radiation. This has positive effects on properties, in particular, such as the push-out or the behavior in a falling-ball test, whereas properties such as the peel adhesions tend to fall. The PSAs are therefore preferably not crosslinked.

### Test Methods

Unless otherwise indicated, the measurements are carried out under test conditions of 23±1° C. and 50±5% relative humidity.

### Softening Point

The figures for the softening point T_{S} of oligomeric and polymeric compounds, such as of the resins, for example, are based on the ring & ball method according to DIN EN 1427:2007 with corresponding application of the provisions (investigation of the oligomer sample or polymer sample instead of bitumen, with the procedure otherwise retained); the measurements are made in a glycerol bath.

### Peel Adhesion

The peel strength (peel adhesion) was tested in a method based on PSTC-1.

A strip of the pressure-sensitive adhesive tape, 0.5 cm wide, consisting of a PET film 23 μm thick and etched with trichloroacetic acid and of an adhesive coating applied thereto and 50 μm thick is adhered to the test substrate in the form of an ASTM steel plate by being rolled on back and forth five times using a 4 kg roller.

The surface of the steel plate is cleaned with acetone beforehand. The plate is clamped in, and the self-adhesive strip is peeled from its free end on a tensile testing machine at a peel angle of 180° and a speed of 300 mm/min, and a determination is made of the force needed to achieve this. The results are reported in N/cm and are averaged over three measurements and reported with standardization to the width of the strip in N/cm.

The initial peel adhesion (peel adhesion to steel) was measured immediately after bonding and not more than 10 minutes after bonding.

For the determination of the chemical resistance, the bonded specimens, after rolling, were subjected to different storage regimes.

First of all, all of the specimens after bonding were stored for 24 hours at 23° C. and 50% relative humidity.

As a blank value, specimens were stored in each case for 72 hours at 65° C. and 90% relative humidity. Following the storage, the samples were stored for a further 24 hours at 23° C. and 50% relative humidity and then subjected to measurement.

For the determination of the chemical resistance, the specimens were stored at 65° C. and 90% relative humidity in oleic acid (CAS No. 112-80-1, grade with a purity of at least >90%) or in a 75:25 (vol%) mixture of ethanol and water. For the ethanol/water storage a closeable vessel was used in order to prevent loss of ethanol by evaporation. Following storage, the specimens are first rinsed off with distilled water and then stored for 24 hours at 23° C. and 50% relative humidity. Only then was the peel adhesion measured as described above. The retention of the peel adhesion is calculated through the ratio of the measurement after storage in oleic acid or ethanol/water (in a ratio of 75/25) to the blank value.

### Rolling Ball Tack

The rolling ball tack was measured by the PSTC-6 method (Test Methods for Pressure Sensitive Adhesive Tapes, 15^{th} edition; publisher: Pressure Sensitive Tape Council, Northbrook (Ill.), USA), with the following modifications being made:
use of stainless steel ball bearing balls (stainless steel 1.4401), diameter 7/16 inch, mass 5.7 g
preparation of balls: thorough cleaning with cotton wool and acetone; the clean balls prior to the measurement series are stored in an acetone bath (balls are completely surrounded by the acetone) for 15 minutes; at least 30 minutes before the start of measurement, the balls are removed from the acetone bath and stored open under standard conditions (23±1° C., 50±5% relative humidity) for drying and conditioning
each ball is used only for one measurement.

The tack was determined as follows: as a measure of the tack with a very short contact time, a measurement was made of what is called the rolling ball tack. A strip of the adhesive tape about 25 cm long was fastened under tension horizontally on the test plane with the adhesive side upward. For the measurement, the steel ball was accelerated under the Earth's gravity by rolling down a ramp with a height of 65 mm (angle of inclination: 21°). From the ramp, the steel ball was directed immediately onto the adhesive surface of the sample. A measurement was made of the distance travelled on the adhesive until the ball reached standstill. The rolling path length thus determined serves here as an inverse measure of the tack of the self-adhesive composition (in other words, the shorter the rolling distance, the greater the tack, and vice versa). The respective measurement was obtained (as a length report in mm) from the average value of five individual measurements on five different strips of each adhesive tape.

### Falling Ball Test (Impact Toughness, Ball Drop)

A square, frame-shaped sample was cut out of the adhesive tape under test (outside dimensions 33 mm×33 mm; border width 3.0 mm; inside dimensions (window opening) 27 mm×27 mm). This sample was adhered to an ABS frame (outside dimensions 50 mm×50 mm; border width 12.5 mm; inside dimensions (window opening) 25 mm×25 mm; thickness 3 mm). Adhered on the other side of the double-sided adhesive tape was a PMMA window of 35 mm×35 mm. ABS frame, adhesive tape frame and PMMA window were bonded such that the geometric centers and the diagonals each lay on top of one another (corner on corner). The bond area was 360 mm². The bond was pressed at 10 bar and 23° C. for 5 s and stored for 24 hours with conditioning at 23° C./50% relative humidity.

Immediately after storage, the adhesive assembly composed of ABS frame, adhesive tape and PMMA sheet was placed with the protruding edges of the ABS frame onto a frame structure (sample holder) in such a way that the assembly was oriented horizontally and the PMMA sheet pointed downward, hanging freely. A steel ball with the weight indicated in each case was dropped perpendicularly, centered on the PMMA sheet, from a height of 250 cm (through the window of the ABS frame) onto the sample arranged in this way (measuring conditions 23° C., 50% relative humidity). Three tests were carried out with each sample, unless the PMMA sheet had become detached beforehand.

The ball drop test is deemed to be passed if the adhesive bond has not detached in any of the three tests.

The maximum height at which the test is still passed is reported as the measurement value.

### Push-Out Strength (Z-Plane)

The push-out test provides information on the extent to which the bond of a component in a frame-shaped body, such as of a window or display in a housing, is resistant.

A rectangular, frame-shaped sample was cut out of the adhesive tape under test (outside dimensions 43 mm×33 mm; border width 2.0 mm in each case; inside dimensions (window opening) 39 mm×29 mm, bond area 288 mm² on each of the top and bottom sides). This sample was adhered to a rectangular ABS plastic frame (ABS=acrylonitrile-butadiene-styrene copolymers) (outside dimensions 50 mm×40 mm; border width of the long borders 8 mm in each case; border width of the short borders 10 mm in each case; inside dimensions (window opening) 30 mm×24 mm; thickness 3 mm). Adhered on the other side of the double-sided adhesive tape sample was a rectangular PMMA sheet (PMMA=polymethyl methacrylate) with dimensions of 45 mm×35 mm. The full bond area of the adhesive tape available was utilized. The ABS frame, adhesive tape sample and PMMA window were bonded such that the geometric centers, the bisecting lines of the acute diagonal angles and the bisecting lines of the obtuse diagonal angles of the rectangles each lay on top of one another (corner on corner, long sides on long sides, short sides on short sides). The bond area was 288 mm². The bond was pressed at 10 bar and 23° C. for 5 s and stored for 24 hours with conditioning at 23° C./50% relative humidity.

Immediately after storage, the adhesive assembly composed of ABS frame, adhesive tape and PMMA sheet was placed with the protruding edges of the ABS frame onto a frame structure (sample holder) in such a way that the assembly was oriented horizontally and the PMMA sheet pointed downward, hanging freely.

A plunger is then moved through the window of the ABS frame, perpendicularly from above, at a constant speed of 10 mm/s, so that it presses centrally onto the PMMA plate, and a record is made of the respective force (determined from respective pressure and contact area between plunger and plate) as a function of the time from the first contact of the plunger with the PMMA plate until shortly after the plate has fallen (measuring conditions 23° C., 50% relative humidity). The force acting immediately prior to the failure of the adhesive bond between PMMA plate and ABS frame (maximum force Fₘₐₓ in the force-time diagram in N) is recorded as the answer of the push-out test.

### Static Glass Transition Temperature Tg

Glass transition points—referred to synonymously as glass transition temperatures—are reported as the result of measurements by dynamic scanning calorimetry (DSC) in accordance with DIN 53 765, especially sections 7.1 and 8.1, but with uniform heating and cooling rates of 10 K/min in all heating and cooling steps (compare DIN 53 765; section 7.1; note 1). The initial sample mass is 20 mg.

The intention of the text below is to illustrate the invention using a number of examples, without thereby wishing to subject the invention to unnecessary restriction.

### Preparation of the PSAs

The pressure-sensitive adhesives (PSAs) set out in the examples were homogenized as solvent-based compositions in a kneading apparatus with a double-sigma kneading hook. The solvent used was butanone (methyl ethyl ketone, 2-butanone). The kneading apparatus was cooled by means of water cooling.

First of all, in a first step, the solid acrylonitrile-butadiene rubber was pre-swollen with the same amount of butanone at 23° C. for 12 hours. This preliminary batch, as it is called, was then kneaded for 2 hours. Subsequently, again, the amount of butanone selected above and, optionally, the liquid NBR rubber were added in two steps with kneading in each case for 10 minutes. Thereafter the tackifier resin was added as a solution in butanone with a solids content of 50%, and homogeneous kneading was continued for 20 minutes more. The final solids content is adjusted to 30 wt % by addition of butanone.

### Production of the Test Specimens

The PSA was coated onto a PET film, 23 μm thick and etched with trichloroacetic acid, by means of a coating knife on a commercial laboratory coating bench (for example from the company SMO (Sondermaschinen Oschersleben GmbH)). The butanone was evaporated in a forced air drying cabinet at 105° C. for 10 minutes. The slot width during coating was adjusted so as to achieve a coat weight of 50 g/m² following evaporation of the solvent. The films freed from the solvent were subsequently lined with siliconized PET film and stored pending further testing at 23° C. and 50% relative humidity.

### EXAMPLES

| | Example 1 | Example 2 | Example 3 | Example 4 | Example 5 |
|---|---|---|---|---|---|
| | Initial | Initial | Initial | Initial | Initial |
| | mass of | mass of | mass of | mass of | mass of |
| Raw material | solids [%] | solids [%] | solids [%] | solids [%] | solids [%] |
| Nipol | 0% | 0% | 0% | 0% | 0% |
| N41H80 | | | | | |
| Nipol 401 | 67% | 67% | 67% | 50% | 57% |
| Nipol DN | 0% | 0% | 0% | 0% | 0% |
| 2850 | | | | | |
| Nipol 1042 S | 0% | 0% | 0% | 0% | 0% |
| Dertophene | 33% | 0% | 0% | 0% | 0% |
| T 110 | | | | | |
| Dertophene | 0% | 0% | 0% | 33% | 33% |
| T | | | | | |
| Rosin | 0% | 0% | 0% | 0% | 0% |
| Novares | 0% | 33% | 0% | 0% | 0% |
| TK 90 | | | | | |
| Cumar 130 | 0% | 0% | 33% | 0% | 0% |
| Novares | 0% | 0% | 0% | 0% | 0% |
| C120VL | | | | | |
| Picco AR85 | 0% | 0% | 0% | 0% | 0% |
| Nipol 1312 | 0% | 0% | 0% | 17% | 10% |
| LV | | | | | |

| | Example 6 | Example 7 | Example 8 | Example 9 |
|---|---|---|---|---|
| | Initial mass | Initial mass | Initial mass | Initial mass |
| Raw material | of solids [%] | of solids [%] | of solids [%] | of solids [%] |
| Nipol N41H80 | 0% | 0% | 0% | 0% |
| Nipol 401 | 62% | 0% | 0% | 50% |
| Nipol DN 2850 | 0% | 67% | 57% | 0% |
| Nipol 1042 S | 0% | 0% | 0% | 0% |
| Dertophene | 0% | 0% | 0% | 0% |
| T 110 | | | | |
| Dertophene T | 33% | 0% | 0% | 50% |
| Rosin | 0% | 0% | 0% | 0% |
| Novares TK 90 | 0% | 0% | 0% | 0% |
| Cumar 130 | 0% | 0% | 0% | 0% |
| Novares | 0% | 0% | 0% | 0% |
| C120VL | | | | |
| Picco AR85 | 0% | 33% | 29% | 0% |
| Nipol 1312 LV | 5% | 0% | 14% | 0% |

Initial mass of solids [%] denotes in each case [wt %].

| | Comparative | Comparative | Comparative | Comparative |
|---|---|---|---|---|
| | example 1 | example 2 | example 3 | example 4 |
| | Initial mass | Initial mass | Initial mass | Initial mass |
| Raw material | of solids [%] | of solids [%] | of solids [%] | of solids [%] |
| Nipol N41H80 | 50% | 0% | 0% | 57% |
| Nipol 401 | 0% | 0% | 0% | 0% |
| Nipol DN 2850 | 0% | 0% | 0% | 0% |
| Nipol 1042 S | 0% | 67% | 57% | 0% |
| Dertophene | 50% | 0% | 0% | 0% |
| T 110 | | | | |
| Dertophene T | 0% | 0% | 0% | 0% |
| Rosin | 0% | 0% | 29% | 29% |
| Novares TK 90 | 0% | 0% | 0% | 0% |
| Cumar 130 | 0% | 0% | 0% | 0% |
| Novares | 0% | 0% | 0% | 0% |
| C120VL | | | | |
| Picco AR85 | 0% | 33% | 0% | 0% |
| Nipol 1312 LV | 0% | 0% | 14% | 14% |

| | | Mooney viscosity | |
|---|---|---|---|
| | ACN content | ML 1 + 4, 100° C. | T_{g} |
| Name | [wt %] | [MU] | [° C.] |
| Nipol 401 | 18.5 | 73 to 83 | −37 |
| Nipol 1312 LV | 26.5 | 9000 to 16000* | −23 |
| Nipol DN 2850 | 28.0 | 45 to 55 | −22 |
| Nipol 1042 S | 33.5 | 73 to 83 | −17 |
| Nipol N41H80 | 41.0 | 72 to 88 | −9 |

*For Nipol 1312LV the Brookfield viscosity is stated in [mPa * s], measured with spindle 4, 12 rpm, 50° C.

| Name | Chemical basis | Manufacturer | Softening point | |
|---|---|---|---|---|
| Dertophene | Terpene-phenolic resin | DRT | 112° | C. |
| T 110 | | | | |
| Dertophene | Terpene-phenolic resin | DRT | 95° | C. |
| T | | | | |
| Rosin | Abietic acid | | 85° | C. |
| Novares | Aliphatically modified | Rütgers | 85 to 95° | C. |
| TK 90 | hydrocarbon resin | | | |
| Cumar 130 | Coumarone.Indene | Neville | 125 to 135° | C. |
| | resin | | | |
| Novares | Coumarone.Indene | Rütgers | 115 to 125° | C. |
| C120-VL | resin | | | |
| Picco AR85 | Aromatically modified | Eastman | 87° | C. |
| | hydrocarbon resin | | | |
| | Eastman | | | |

| | | Example | Example | Example | Example | Example |
|---|---|---|---|---|---|---|
| Test | | 1 | 2 | 3 | 4 | 5 |
| Peel adhesion | [N/cm] | 5.9 | 6.3 | 3.8 | 12.4 | 8.4 |
| ASTM steel | | | | | | |
| Blank value | [N/cm] | 16.5 | 26.0 | 11.0 | 23.4 | 27.5 |
| (3 d, 65° C.) | | | | | | |
| 3 d, 65° C., | [N/cm] | 4.9 | 7.9 | 6.4 | 4.9 | 6.1 |
| oleic acid | | | | | | |
| 3 d, 65° C., | [N/cm] | 4.46 | 5.9 | 9.9 | 5.35 | 8.4 |
| EtOH/H₂O | | | | | | |
| Push-out | [N] | 46 | | | 41 | 47 |
| Ball-drop | [cm] | 230 | | | 250 | 250 |
| Rolling ball | [mm] | 46 | 54 | 49 | 17 | 28 |
| tack | | | | | | |
| | | Example | Example | Example | | Example |
| Test | | 6 | 7 | 8 | | 9 |
| Peel adhesion | [N/cm] | 12.8 | 5.2 | 12.6 | | 7.8 |
| ASTM steel | | | | | | |
| Blank value | [N/cm] | 28.7 | 10.6 | 28.3 | | 8.0 |
| (3 d, 65° C.) | | | | | | |
| 3 d, 65° C., | [N/cm] | 5.5 | 3.6 | 4.6 | | 4.3 |
| oleic acid | | | | | | |
| 3 d, 65° C., | [N/cm] | 9.5 | 5.7 | 4.9 | | 10.4 |
| EtOH/H₂O | | | | | | |
| Push-out | [N] | 57 | | | | 94 |
| Ball-drop | [cm] | 250 | | | | 250 |
| Rolling ball | [mm] | 52 | 48 | 23 | | 30 |
| tack | | | | | | |

| | | Com- | Com- | Com- | Com- |
|---|---|---|---|---|---|
| | | parative | parative | parative | parative |
| Test | | example 1 | example 2 | example 3 | example 4 |
| Peel adhesion | [N/cm] | dead | dead | dead | 2.8 |
| ASTM steel | | | | | |
| Blank value | [N/cm] | | | | 4.1 |
| (3 d, 65° C.) | | | | | |
| 3 d, 65° C., | [N/cm] | | | | 0.5 |
| oleic acid | | | | | |
| 3 d, 65° C., | [N/cm] | | | | 0 |
| EtOH/H₂O | | | | | |
| Push-out | [N] | | | | |
| Ball-drop | [cm] | | | | |
| Rolling ball | [mm] | >250 | >250 | >250 | 60 |
| tack | | | | | |

To produce the specimens for the falling-ball and push-out tests, the PSA was coated using the laboratory coating bench onto a siliconized PET film. The coatings were subsequently dried at 105° C. for 10 minutes. The adhesive films with a layer thickness of 50 μm were laminated onto either side of a corona-pretreated PET film 12 μm thick, to give a double-sided adhesive tape specimen.

As is apparent from the examples, the inventive adhesive exhibits significant peel adhesion even after 72 hours' storage in ethanol/water or in hot oleic acid at 65° C.

Surprisingly, and unforeseeably for the skilled person, this improved quality is attributable to the acrylonitrile content in the acrylonitrile-butadiene rubber. Although the chemical resistance of acrylonitrile-butadiene rubber is known and is utilized for many applications in the automotive sector, high resistance toward apolar media (in this case oleic acid) is customarily achieved with a high ACN content. Typically, therefore, acrylonitrile-butadiene rubbers with an ACN content of 41 wt % or more are used. The admixing of rubbers with low ACN contents is generally practiced only for the purpose of adjusting the mechanical properties, but often at the expense of the chemical resistance. Entirely surprisingly it has emerged that exclusively PSAs based on acrylonitrile-butadiene rubbers with an ACN content of less than 30 wt % exhibit sufficient chemical resistance toward apolar media.

Particularly high resistances toward polar and apolar media are achieved with PSAs which contain acrylonitrile-butadiene rubbers with an ACN content of less than 25 wt % and, even more preferably, less than 20 wt %.

It is surprising, moreover, that the PSAs of the invention maintain the good peel adhesion forces not only after exposure to very apolar chemicals (oleic acid, for example) but also to very polar chemicals ethanol/water.

In assessing the resistance, it is not just the absolute level of the peel adhesion that is of interest here, but also the percentage change after exposure to the chemicals, in comparison to the blank value.

The stated chemicals (oleic acid and ethanol/water) are used only as representatives. The PSAs of the invention are also resistant to chemicals such as sebum, perfumes, dilute sulfuric acid, oil/water emulsions and water/oil emulsions of the kind used in cosmetic products, and brake fluid. This list as well is not conclusive, but instead is exemplary in its nature.

The values measured for the falling-ball test (ball-drop) and for the push-out test demonstrate the excellent suitability of the pressure-sensitive adhesives of the invention for the adhesive bonding of windows or displays in housings. A particular surprise here is the shock resistance determined in the falling-ball test.

1. A pressure-sensitive adhesive comprising,
as base polymer, at least one or a plurality of solid acrylonitrile-butadiene rubber(s) and tackifier resins, the fraction of the tackifier resins being 30 to 130 phr,
wherein
the acrylonitrile content in the solid acrylonitrile-butadiene rubber(s) is between 10 and 30 wt %.

2. The pressure-sensitive adhesive as claimed in claim 1, wherein
the base polymer consists only of acrylonitrile-butadiene rubber.

3. The pressure-sensitive adhesive as claimed in claim 1, wherein
the acrylonitrile content in the acrylonitrile-butadiene rubber is between 10 and 25 wt %.

4. The pressure-sensitive adhesive as claimed in claim 1, wherein
the fraction of the tackifier resins is 50 to 120 phr.

5. The pressure-sensitive adhesive as claimed in claim 1, wherein
the tackifier resins comprise terpene-phenolic resins and/or polyterpenes.

6. The pressure-sensitive adhesive as claimed in claim 1, further comprising
at least one liquid acrylonitrile-butadiene rubber, the acrylonitrile content in the liquid acrylonitrile-butadiene rubber(s) being between 10 and 30 wt %.

7. The pressure-sensitive adhesive as claimed in claim 6, wherein
the fraction of the liquid acrylonitrile-butadiene rubbers is up to 20 wt %.

8. The pressure-sensitive adhesive as claimed in claim 1, which consists of a composition only of solid or only of solid and liquid acrylonitrile-butadiene rubber and tackifier resin, and optionally, aging agents and release assistants.

9. The pressure-sensitive adhesive as claimed in claim 1, wherein
apart from the acrylonitrile butadiene rubber and tackifier resin, the fractions of all added substances selected from the group consisting of synthetic rubbers, thermoplastic elastomers, fillers, dyes, aging inhibitors, plasticizers and, release assistants, do not in total exceed 5 wt %.

10. An adhesive tape which is single-sided or double-sided comprising the pressure-sensitive adhesive as claimed in claim 1.

11. The adhesive tape of claim 10, where the coat weight (coating thickness) of the pressure-sensitive adhesive is between 10 and 150 g/m².

12. A method for bonding parts in electronic devices, comprising a step of applying a pressure-sensitive adhesive as claimed in claim 1 to a substrate.

13. A method for bonding decals or labels, comprising a step of applying a pressure-sensitive adhesive as claimed in claim 1 to a substrate.

14. The pressure-sensitive adhesive as claimed in claim 2, wherein, aside from acrylonitrile-butadiene rubber, there is no further polymer in the pressure-sensitive adhesive.

15. The pressure-sensitive adhesive as claimed in claim 3, wherein the acrylonitrile content in the acrylonitrile-butadiene rubber is between 15 and 20 wt %.

16. The pressure-sensitive adhesive as claimed in claim 4, wherein the fraction of the tackifier resins is 60 to 110 phr.

17. The pressure-sensitive adhesive as claimed in claim 7, wherein the fraction of the liquid acrylonitrile-butadiene rubbers is between 1 and 15 wt %.

18. The pressure-sensitive adhesive as claimed in claim 17, wherein the fraction of the liquid acrylonitrile-butadiene rubbers is between 2 and 10 wt %.

19. The pressure-sensitive adhesive as claimed in claim 9, wherein apart from the acrylonitrile butadiene rubber and tackifier resin, the fractions of all added substances, do not in total exceed 5 wt %.

20. The pressure-sensitive adhesive as claimed in claim 19, wherein apart from the acrylonitrile butadiene rubber and tackifier resin, the fractions of all added substances, do not in total exceed 2 wt %.
